(19) United States
(12) Patent Application Publication
(10) Pub. No.: US 2003/0023842 A1
(43) Pub. Date: Jan. 30, 2003

(54) Remote processor reset apparatus and method

(76) Inventors: Kendall A. Honeycutt, Boca Raton, FL (US); Ray Garcia, Boca Raton, FL (US)

Correspondence Address: KAPLAN & GILMAN , L.L.P., 900NROUTE 9 NORTH, WOODBRIDGE, NJ, 07095, US

(21) Appl. No.: 09/915,923

(22) Filed: Jul. 26, 2001

(51) Int. Cl. G06F 15/177

(52) U.S. Cl. 713/2

(57) ABSTRACT

The invention disclosed provides a verification circuit and method for sending an operator-generated signal to a frozen remote computer processor that will be distinguished from an unintentional short circuit. The apparatus includes a USB connective cable having a momentary contact switch able to create a short circuit that is transmitted to a resetting circuit. According to the method of the invention, the user of the computer having a frozen remote processor activates the switch so that the resetting circuit recognizes that an intentional reset request is being sent, and transmits a signal to reboot the processor.

### FIELD OF THE INVENTION

The present invention relates to the field of computer systems, and more particularly to computer systems in which the processor is remote from the monitor. The present application is closely related to a second application being filed concurrently herewith and attached as an appendix.

### BACKGROUND OF THE INVENTION

In pursuit of greater efficiency and better use of space, some organizations have been relocating computer processors (CPUs) to an area remote from the work area of the user. By removing the processor from the workstation, additional space is freed for other purposes. Plural single board computers (SBC) may be used to populate a single rack. Each SBC interfaces to a separate user monitor, keyboard, and mouse, but all SBCs share a common hard disc. According to an exemplary architecture of the present invention, the single drive and plural SBCs operate over a common bus.

Special cabling, such as KVM (Keyboard Video Mouse) extenders or USB repeater cables are utilized to provide appropriate communication speed. Some arrangements have gone to the extent of locating the processors in a secure and locked facility.

Occasionally, all computers encounter problems and become hung, or frozen, preventing the user from performing additional work, frequently losing recent input. Minor computer freezes can often be overcome by deactivating a particular program that is causing the problem, typically by depressing the “control-alternate-delete” keys simultaneously. This method does not work in the case of a full computer freeze, which requires shutting down and rebooting the entire machine. Previously, this shut down would require pressing a “reset” button on the processor that would cut power momentarily and then re-start the computer. Of course, with the processor located remote from the user's workstation, there is no accessible reset button. Re-starting a computer in such a situation might require the user to call a service technician to reset the remote SBC, involving an added delay.

To avoid a service call, some known computer network systems with remotely located mother boards have installed a reset switch at each work station that is connected to the power supply via a bus. This attempt at correcting the problem has been seen to create another problem by resetting, therefore discontinuing operations of, all the SBCs in the system, since they are all connected to a common bus.

To overcome these drawbacks, the present invention provides a method and apparatus for resetting a selected individual processor from a remote location.

### SUMMARY OF THE INVENTION

A remote processor reset apparatus in the form of a USB or other communications circuit and a method are provided for sending an operator-generated signal to a frozen PROCESSOR that will reset the power thereto. The apparatus involves a USB overcurrent protection circuit including a momentary contact switch connected to create an intentional short circuit. According to the method of the invention, the user of the computer having a remote processor activates the switch as a reset request to reboot the processor.

In a preferred embodiment, a microprocessor (CPU) receives and transmits commands. In parallel with the microprocessor system is hardware circuitry for detecting a fault, such as a short circuit. When the processor locks up due to an error, the user may simulate a fault, which serves as a signal that is detected by the hardware and utilized to reset the system.

### BRIEF DESCRIPTION OF THE DRAWINGS

FIG. 1 is a schematic layout of an exemplary architecture of a rack of SBCs connected to a common disc drive located remotely from individual workstations;

FIG. 2 is an electrical schematic diagram of a first portion of a USB overcurrent circuit according to the invention; and

FIG. 3 is an electrical schematic diagram of a second portion of the USB circuit of FIG. 2.

### DETAILED DESCRIPTION OF THE INVENTION

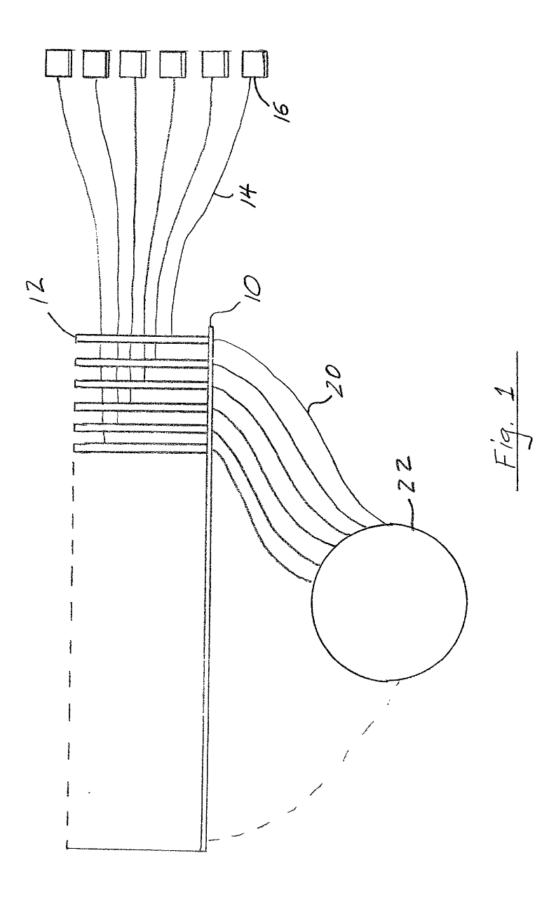

Referring now to the accompanying drawings, FIG. 1 illustrates a schematic layout of the major components of a remote processor computer network system. A rack 10, adapted for securely supporting a plurality of SBCs 12, is mounted at a location that is remote from the workstations 16 of the users of the computer network. Workstations 16 typically each consist of a monitor, a keyboard, and a mouse, not individually numbered. Each SBC 12 is connected to a respective workstation 16 by means of a bus USB connective cable 14. As noted above, to conserve space and cost, individual SBCs 12 do not have individual hard disc drives.

A single hard disc drive 22 is connected to each of SBCs 12 by means of a plurality of connections 20, the number of connections 20 equal to the number of SBCs 12. Connections 20 are made in a manner so that each SBC 12 is able to interact with hard disc drive 22 seamlessly as if the particular SBC 12 and disc drive 22 are a cohesive system. Disc drive 22 is comparatively adapted to receive data from and provide data to a respective SBC 12 individually. The connections 20 are, in actuality, logical connections over a single physical bus, but they may also be accomplished by other means, as are known to those skilled in the art.

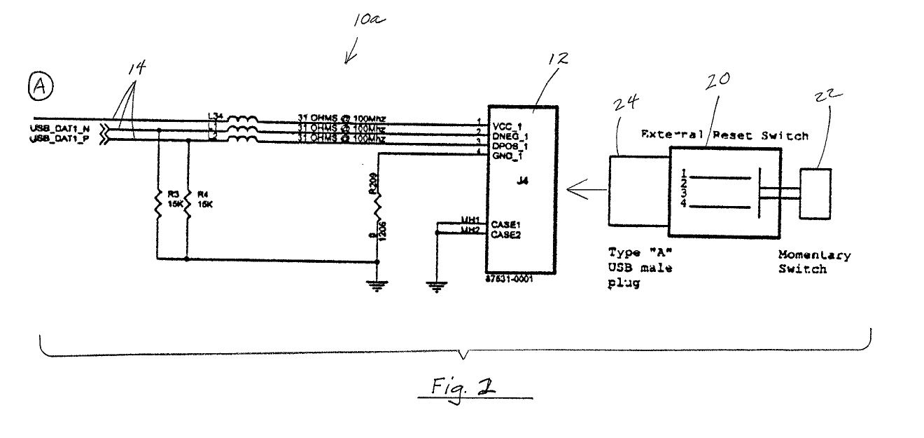

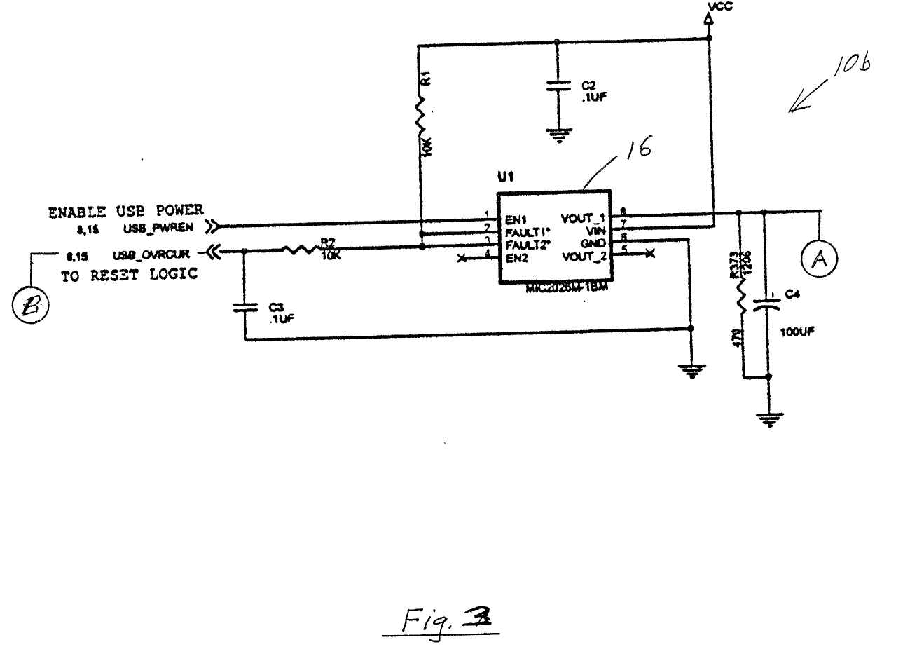

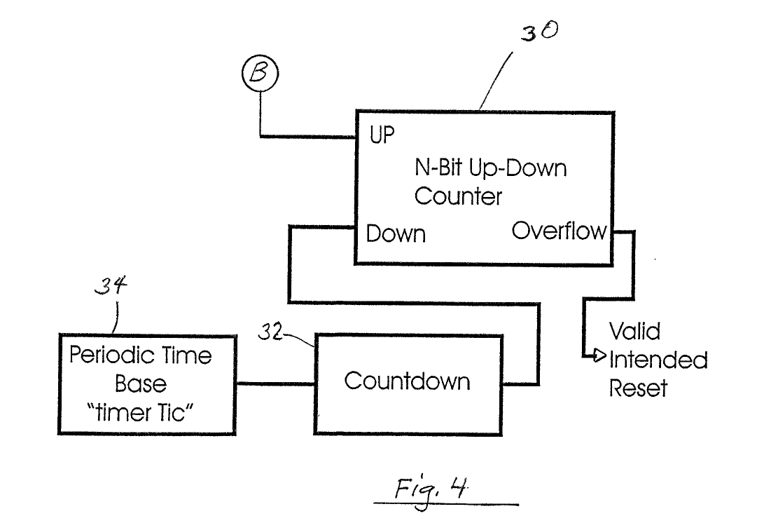

Referring now to FIGS. 2 and 3, a USB connective cable 14 is shown in two portions 14a and 14b that are connected to one another at terminal A, including components for protection of the connected computer against power surges. At an input end, cable 14 has a type A USB female connector 24 with terminals 1, 2, 3, and 4 connected thereto. Cable 14 connects from connector 24 to overcurrent protection unit 26 with intermediate resistors and capacitors inserted therein. A normally open manually operable switch 30 is adapted for engaging USB female connector 24 through integral type A male connector 32 located on one end thereof. A pushbutton 34 is connected in a manner, when depressed, to activate momentary switch 30.

Since the purpose of the present invention is to enable a remote user to restart a computer processor that has become frozen, a signal to the code processing section would be pointless. More specifically, if the processor is “hung”, or locked up, then sending a signal, through a USB port or any other port, will not cause the processor to reset, since the processor will not read the signal. Thus, auxiliary connections are provided from the USB cable to a circuit that are configured to authenticate and respond to a reset request signal when the processor is locked up.

Momentary switch 30 is configured internally to close a selected pair of contacts, for example contacts 1 and 4. The signal of a momentary short circuit initiated by closure of switch 30 is transmitted to terminals 1 and 4 of USB female connector 24, and through cable 14 to a selected contact, for example terminal 8 of overcurrent protection unit 26. The short circuit signal is then transmitted to connection B of counter circuit 40 depicted in FIG. 4, at connection B.

As will be appreciated by those skilled in the trade, a short circuit is offered as an exemplary but not exclusive, form of fault that may be simulated intentionally according to the present invention. Thus, the principles described herein pertain to a short circuit and other types of computer fault. The fault receiving circuit would then respond by generating and transmitting a reset request signal to the power supply to momentarily disconnect power and then reconnect power, causing the computer processor to reset.

While the present invention is described with respect to specific embodiments thereof, it is recognized that various modifications and variations thereof may be made without departing from the scope and spirit of the invention, which is more clearly understood by reference to the claims appended hereto.

[image]

What is claimed is:

1. A remote computer processor reset apparatus comprising a manually operable switch, a connective circuit in electrical communication at a first end thereof with the manually operable switch and connected at a second end thereof to the computer processor so as to transmit a responsive reset signal thereto.

2. The remote computer processor reset apparatus as described in claim 1, wherein the switch is adapted to transmit a short circuit signal to the computer processor.

3. The remote computer processor reset apparatus as described in clam 1, wherein the manually operable switch is a momentary contact switch.

4. A remote computer processor reset apparatus having means for remotely resetting the processor when the processor is frozen, comprising:
a) means for transmitting an input signal from a signal generator to a resetting device;
b) means for receiving said input signal at said resetting device; and
c) means for responding to the received input signal so as to remotely reset the processor.

5. The apparatus for resetting a remote computer processor as described in claim 4, wherein the means for generating a signal comprises a momentary contact switch.

6. The apparatus for resetting a remote computer processor as described in claim 4, wherein the signal transmitting means is connected to the auxiliary circuit by a USB connective cable.

7. A method for resetting a remote computer processor comprising the steps of:
a) transmitting an input signal from a signal generator to a resetting device;
b) receiving the input signal at the resetting device; and
c) in response to the step of receiving the signal, resetting the processor.
